(19) United States
(12) Patent Application Publication
(10) Pub. No.: US 2007/0176410 A1
(43) Pub. Date: Aug. 2, 2007

(54) Label for sealing over a transition between axially different cross-sections

(76) Inventors: Robert Unglert, Munchen (DE); Ulrich Moosheimer, Hohenkammern (DE)

Correspondence Address: WILLIAM COLLARD;COLLARD & ROE, P.C., 1077 NORTHERN BOULEVARD, ROSLYN, NY, 11576, US

(21) Appl. No.: 10/589,367

(22) PCT Filed: Oct. 27, 2004
(86) PCT No.: PCT/EP04/12164

§ 371 Date: Aug. 15, 2006

(30) Foreign Application Priority Data
Feb. 18, 2004 (DE) 10 2004 007 971.4

(51) Int. Cl. B42D 15/00; B23B 7/12

(52) U.S. Cl. 283/67; 283/81

(57) ABSTRACT

The first application part is applied to one body to be sealed over and the second application part is applied to the other body to be sealed over. These application parts are joined to one another solely via a transition part, which is small compared to the application parts, so that a distant separation exists between the application parts, and the varying longitudinal expansion of the label when labeling the different circumferences is made sufficient. The application parts are preferably offset from one another in such a manner that an imaginary linear widening of the first application part of an infinite width only slightly overlaps the second application part or does not overlap it at all, the widening extending beyond the transition part in a transverse direction of the label. The application parts thus form, when applying them, a respective leading part and trailing part. At both the beginning as well as the end of the application process, only one of the bodies to be sealed over is labeled at a time, i.e., lateral surfaces of varying diameters are, to a large extent, provided with the corresponding label part in succession and not simultaneously.

The present invention pertains to a label for sealing over a transition between axially different cross-sections, as well as to a coaxial arrangement of two bodies that can be separated from one another and the transition of which is sealed over with a label of this type.

One example of sealing over a transition between axially different cross-sections is the sealing of a container with a sealing cap that has a different outside diameter than the remainder of the container. Another example is the sealing of a syringe arrangement with a syringe body and a protective cap attached to the syringe body. The protective cap frequently has a significantly smaller diameter than the syringe body.

The seal needs to ensure that the syringe arrangement remains sealed by means of the protective cap until it is used, wherein an intact seal should also make it possible to determine that the syringe arrangement has been sealed up to this point. If the seal is damaged, however, this indicates that the protective cap could possibly have been opened in the meantime. In this case, the syringe arrangement can no longer be used because the needle covered by the protective cap could have been contaminated or the filling of the syringe body could have been manipulated.

Corresponding seals should also provide a definitive verification of the integrity of container arrangement seals in order to ensure that the contents of the container were not manipulated. Such a seal therefore fulfills a highly safety-relevant function, particularly on containers for pharmaceutical products.

A seal between axially different cross-sections essentially cannot be produced without creases with simple, strip-shaped self-adhesive labels. Another problem can be seen in that conventional labels cannot be applied by means of a conventional dispensing device such that they lie on two bodies of significantly different diameters, for example, a syringe body and a protective cap. Labeling machines are unable to simultaneously reach a syringe body and the region underneath the syringe body.

In the aforementioned instances, it would be alternatively possible to realize the seal in the form of a shrink-on label (sleeve-label) that is tubularly placed over the transition to be sealed and subsequently shrunk on under the influence of heat. In this case, the geometry of the label is adapted in that the heat shrinking foil, of which the label consists, contracts as far as permitted by the given geometry of the body to be sealed over.

However, the sealing by means of a shrink-on label may be problematic. The material selection is very limited because only foils with corresponding shrinkage properties may be considered. On labels that carry lettering, the lettering may be distorted in an unsightly fashion due to the shrinkage of the label. With respect to containers for pharmaceutical products, particularly syringe bodies with perfusion solutions containing active substances, a seal produced with the aid of a shrink-on label is frequently prohibited due to the heat required for triggering the shrinking process, namely because many pharmaceutical agents are extremely heat-sensitive.

In light of the above-described problems, the present invention aims to develop a label for securely sealing over a transition between axially different cross-sections, particularly transitions between a syringe body and a corresponding protective cap, wherein said label does not require the influence of heat in order to be applied without creases. It should furthermore be possible to realize a mechanized application.

The present invention is also based on the objective of developing a coaxial arrangement of two bodies with cylindrical and/or prismatic and/or conical regions that can be separated from one another, wherein the bodies have different cross-sections in the region of their transition, particularly to develop an arrangement with a syringe body and a protective cap in which the transition between the bodies is reliably sealed over.

The present invention is also based on the objective of developing a method for sealing over a coaxial arrangement of two bodies with cylindrical and/or prismatic and/or conical regions that can be separated from one another and have different cross-sections in the region of their transition, wherein said method can be easily automated and makes it possible to inexpensively produce a reliable seal without distortions and with the lowest reject rate possible.

The term cylindrical and/or prismatic also refers to similar geometries in the following description, i.e., this term essentially includes all bodies with surface lines that at least sectionally extend axially parallel to one another.

According to one aspect of the invention, this objective is attained with a label according to claim 1. Advantageous embodiments of the invention may be realized in accordance with one of claims 2-19.

The first application part is designed for being arranged on one of the bodies to be sealed over and the second application part is designed for being arranged on the other body to be sealed over. The application parts are only connected to one another by a small (in relation to the application parts) transition part such that a distant separation exists between the application parts and a sufficiently varying longitudinal expansion of the label is realized when labeling the different circumferences. In other words, the tensile forces that are effective during the application process are largely decoupled. The surface area of the transition part is preferably smaller than one-half, particularly smaller than one-fourth of at least the larger application part, preferably each of the application parts. The inventive solution is simple and cost-efficient. The verification of the seal integrity can be incorporated into the conventionally required identification label. Customary labeling devices of the user, for example, a pharmaceutical company, can still be used without requiring an additional step.

A thermal effect is not required. However, it is possible to realize the base layer or parts of the base layer of a heat shrinking foil material. A locally limited application of heat in the region of the transition part therefore prevents the formation of creases, namely also with complicated geometries, as well as unintentional tearing. If the heating process for realizing the shrinkage is only carried out locally in the region of the transition part, for example, by means of correspondingly focused infrared radiation or laser radiation, impermissible heating of the sealed-over body can be prevented in most instances. Most popular foil materials, particularly conventional plastic foils (e.g., PET), may be considered as materials for the base plate, wherein it would also be conceivable to realize single-layer and multilayer variations. It would even be possible to realize a paper-based layer.

With respect to the selection of suitable adhesives for the self-adhesive coating, one can fall back on the adhesives used on conventional labels, particularly popular pressure-sensitive adhesives, e.g., acrylate-based adhesives.

The decoupling of the application parts can be improved with suitable punchings and/or slits in the transition part. These punchings or slits may also simplify the defined tearing of the seal during its removal. Punching lines that are bent or angled in the label plane as well as intersecting punching lines are particularly suitable for this purpose. The defined tearing can also be improved with perforations.

According to one particularly preferred embodiment of the invention, the label has a shape in which the first and the second application part are offset relative to one another in such a way that an imaginary, virtual linear extension of the first application part that extends beyond the transition part in the longitudinal direction of the label and has an infinite length does not overlap the second application part. This embodiment ensures that each application part only lies on one of the bodies to be sealed over and does not project as long as it is properly applied. When the label is properly applied, the longitudinal direction corresponds to the tangential direction of the bodies to be labeled and therefore usually to the dispensing direction.

In another particularly preferred label shape, the first and the second application part are offset relative to one another in such a way that an imaginary, virtual linear widening of the first application part that extends beyond the transition part in the transverse direction of the label and has an infinite width partially overlaps the second application part, preferably only slightly (over less than one-third the length of one of the application parts, particularly over less than one-fourth the length of one of the application parts) or not at all. This label shape provides particular advantages during the application of the label: the application parts form a leading and a trailing part when they are applied. This means that only one respective body to be sealed over is labeled at the beginning and at the end of the dispensing process, i.e., surface areas of different diameters are largely provided with the corresponding label part successively and not simultaneously.

If the label is applied properly, the transverse direction corresponds to the axial direction of the bodies to be labeled.

According to another aspect of the invention, the objective is attained with an arrangement according to claim 20. Advantageous embodiments of the invention may be realized in accordance with one of claims 21-25.

According to another aspect of the invention, the objective is attained with a method according to claim 26. Advantageous embodiments of the inventive method may be realized in accordance with one of claims 27-30.

According to the inventive method, the application parts to be respectively applied to the bodies to be sealed over are at least partially applied at different times such that the method can be easily mechanized without causing distortions of the label at the transition between the different cross-sectional shapes of the bodies to be sealed over. The application on one body is largely decoupled from the application on the other body with respect to the occurring forces. It is particularly advantageous to make available inventive labels in one of their different embodiments for carrying out the inventive method.

Within the scope of the present invention, any described or suggested variation of the invention may be particularly advantageous depending on the respectively applicable economical and technical conditions. If not explicitly mentioned otherwise or as far as technically feasible, individual characteristics of the described embodiments can be interchanged or combined with one another.

Examples of preferred embodiments of the present invention are described in greater detail below with reference to the corresponding figures. The figures show purely schematic representations and are not drawn true-to-scale. Identical elements are identified by the same reference symbols in the individual figures to the extent deemed sensible.

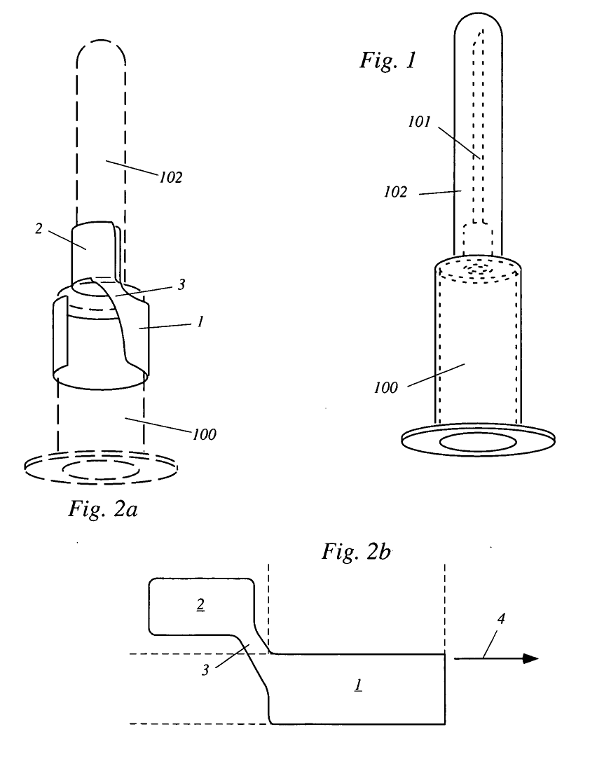

FIG. 1 shows a perspective representation of an arrangement of a syringe body and a protective cap that needs to be sealed over with an inventive label.

FIG. 2a shows the arrangement according to FIG. 1 with an inventive label applied thereon, wherein this arrangement is indicated with broken lines in a perspective representation.

FIG. 2b shows the label according to FIG. 2 in the form of a developed view, wherein virtual linear extensions of an application part are indicated with thin broken lines and an arrow indicates the preferred dispensing direction.

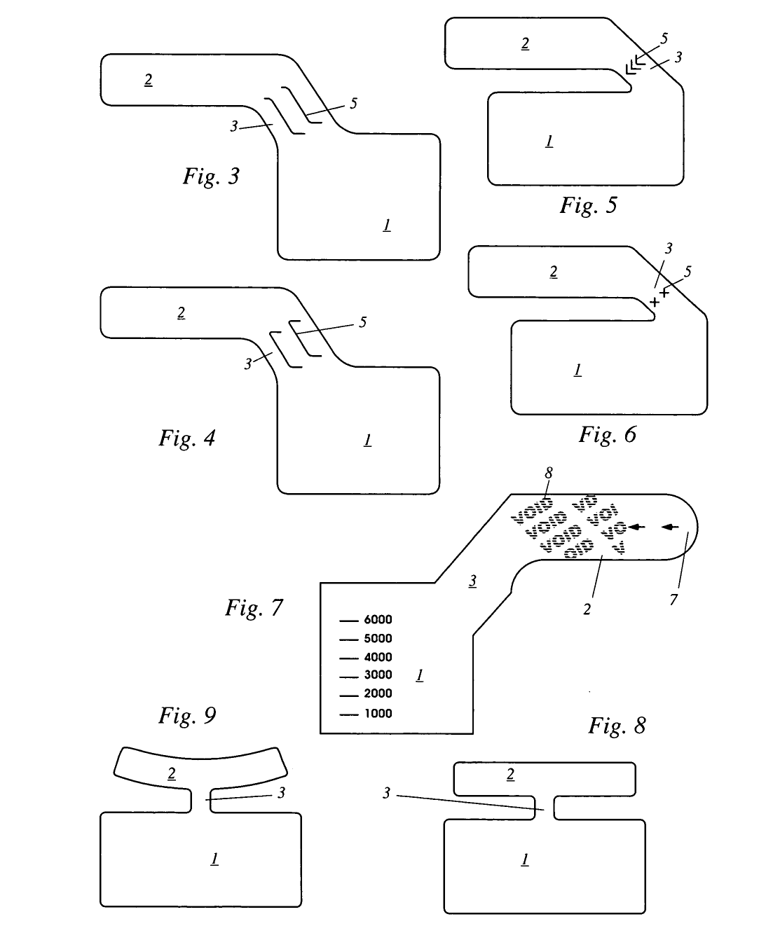

FIG. 3 shows a label that is designed similar to that shown in FIG. 2a and features angled punching lines in the transition part.

FIG. 4 shows a label that is designed similar to that shown in FIG. 3 and can be distinguished from the label according to FIG. 3 by differently configured punching lines.

FIG. 5 shows a label, in which both application parts largely extent adjacent to one another in the longitudinal direction and angled punching lines are provided in the transition part.

FIG. 6 shows a label that is designed similar to that shown in FIG. 5 and can be distinguished from the label according to FIG. 5 in that intersecting punching lines are provided.

FIG. 7 shows a label that is designed similar to that shown in FIGS. 2a-4 and features a pull tab on one application part and a scale printed on the other application part.

FIG. 8 shows another inventive label, in which the transition part is realized in the form of a contraction of the label contour.

FIG. 9 shows a label that is designed similar to that shown in FIG. 8, wherein one of the application parts is realized, however, in an arc-shaped fashion in order to be applied on a conical body.

The syringe arrangement shown in FIG. 1 features a syringe body 100 with a needle 101 that is covered by an annular projection 103 of a protective cap 102 arranged coaxial to the syringe body 100. The plunger of the syringe is not shown. Concealed lines are only partly illustrated and indicated with broken lines. An arrangement of this type is transformed into an inventive arrangement according to FIG. 2a by sealing the transition between the syringe body 100 and the protective cap 102 with an inventive label.

FIGS. 2a shows a syringe arrangement according to FIG. 1 that is merely indicated with broken lines in order to provide a better overview. The first application part 1 and the second application part 2 are connected to one another by the narrow transition part 3 and therefore largely decoupled from one another. Each application part 1, 2 extends over the majority of the circumference of the respective body, on which it is applied. It would also be possible to realize a wraparound arrangement, i.e., an arrangement in which one or both application parts 1, 2 overlap themselves.

According to FIG. 2b, both application parts 1, 2 are offset relative to one another in the longitudinal direction as well as in the transverse direction. This is respectively indicated in the form of an extension (horizontal in the figure) that is indicated with broken lines and a widening (vertical in the figure) of the first application part 1. When dispensing the labels in the (longitudinal) direction indicated by the arrow 4, the first application part 1 consequently functions as a leading part and the second application part functions as a trailing part. The application parts 1, 2 are respectively applied on one of the bodies 100, 102 to be sealed over during the dispensing process. The dispensing, in principle, may also be carried out in the opposite direction.

In the labels shown in FIGS. 3-9, the preferred dispensing direction (longitudinal direction) also extends in the transverse direction referred to the plane of projection, i.e., horizontally.

The labels shown in FIG. 3 and FIG. 4 have a largely identical design and, analogous to the label shown in FIG. 2b, feature punching lines 5 with curvatures in the region of the transition part 3. These punching lines contribute to the decoupling of the application parts 2, 3 from one another and also make it possible to tear the label at a defined location when the bodies sealed over with the label are turned relative to one another.

The labels illustrated in FIG. 5 and FIG. 6 also feature punching lines 5 in the transition part 3. The defined tearing is promoted by the angled (FIG. 5) or intersecting (FIG. 6) configuration of the punching lines 5.

The embodiment shown in FIG. 7 features a largely transparent base layer in the region of the first application part 1. The scale 6 printed on the first application part 1 therefore may serve as a dosing aid once it is glued on a transparent syringe body 100 or another transparent container. The second application part 2 features a pull tab 7, on the underside of which the adhesive force of the pressure-sensitive adhesive coating is neutralized or diminished. A voiding foil structure that may, in principle, be realized analogous to conventional voiding foils is optionally provided in the region of the second application part 2 in order to verify the integrity of the seal. When the pull tab 7 is lifted, the voiding foil structure splits parallel to the label plane (plane of projection) and the words void 8 appear.

FIG. 8 shows an inventive label, in which the transition part 3 is realized in the form of a contraction of the label contour. The label shown in FIG. 9 is realized similar thereto, wherein the arc shape of the second application part 2 is modeled on the developed view of a truncated cone in order to be glued on a conical body.

Conventional printed information for identifying the content of arrangements to be sealed over is not illustrated in FIGS. 2a-9.

1-30. (canceled)

31. A label for sealing over a transition between axially different cross-sections, featuring a base layer with a first application part and a second application part that is connected to the first application part by means of a transition part, as well as a self-adhesive coating that is provided at least sectionally on the underside of the first and the second application part of the base layer, wherein the surface area of the transition part is smaller than the surface area of each of the application parts.

32. The label according to claim 31, wherein the first and the second application part are arranged offset relative to one another in such a way that an imaginary, virtual linear extension of the first application part that extends beyond the transition part in the transverse direction of the label and has an infinite length only overlaps the second application part partially such that one of the application parts functions as a leading part and the other application part functions as a trailing part when the label is applied properly.

33. The label according to claim 32, wherein the imaginary, virtual linear widening of the first application part that extends beyond the transition part in the transverse direction of the label and has an infinite width only overlaps the second application part to such a degree that the length of the overlapping region does not exceed one-third the length of one of the application parts.

34. The label according to claim 33, wherein the imaginary, virtual linear widening of the first application part that extends beyond the transition part in the transverse direction of the label and has an infinite width only overlaps the second application part to such a degree that the length of the overlapping region does not exceed one-fourth the length of one of the application parts.

35. The label according to claim 34, wherein the imaginary, virtual linear widening of the first application part that extends beyond the transition part in the transverse direction of the label and has an infinite width only overlaps the second application part to such a degree that the length of the overlapping region does not exceed one-third the length of one of the application parts.

36. The label according to claim 35, wherein the first and the second application part are arranged offset relative to one another in such a way that an imaginary, virtual linear widening of the first application part that extends beyond the transition part in the transverse direction of the label and has an infinite width does not overlap the second application part.

37. The label according to claim 31, wherein the first and the second application part are arranged offset relative to one another in such a way that an imaginary, virtual linear extension of the first application part that extends beyond the transition part in the longitudinal direction of the label and has an infinite length only overlaps the second application part partially.

38. The label according to claim 37, wherein the first and the second application part are arranged offset relative to one another in such a way that an imaginary, virtual linear extension of the first application part that extends beyond the transition part in the longitudinal direction of the label and has an infinite length does not overlap the second application part.

39. The label according to claim 31, wherein the base layer features weakenings in the region of the transition part.

40. The label according to claim 39, wherein the weakenings are realized in the form of punching lines.

41. The label according to claim 31, wherein the transition part forms a narrowing of the label contour.

42. The label according to claim 41, wherein the transition part forms a contraction of the label contour.

43. The label according to claim 31 featuring printed information.

44. The label according to claim 31, wherein at least sections of the base layer are realized in an at least partially transparent fashion.

45. The label according to claim 31 featuring a voiding foil structure.

46. The label according to claim 31 featuring at least one detachable receipt section.

47. The label according to claim 31 featuring a pull tab.

48. The label according to claim 31 featuring a perforation at the transition between the transition part and one of the application parts.

49. The label according to claim 31, wherein the base layer consists at least sectionally of a heat shrinking foil material.

50. A coaxial arrangement of two separable bodies with at least one of a cylindrical region, a prismatic region and a conical region, wherein the bodies have different cross-sections in the region of their transition, and wherein the transition is sealed over with a label featuring a base layer with a first application part and a second application part that is connected to the first application part by means of a transition part, as well as a self-adhesive coating that is provided at least sectionally on the underside of the first and the second application part of the base layer, wherein the surface area of the transition part is smaller than the surface area of each of the application parts, in such a way that the first application part of the label is fixed on one of the bodies and the second application part of the label is fixed on the other body.

51. The arrangement according to claim 50, wherein the first application part extends over more than one-half the circumference of one of the bodies and the second application part extends over more than one-half the circumference of the other body, and wherein the transition part extends over less than one-fourth of the smaller of the two circumferences.

52. The arrangement according to claim 50, wherein the first application part of the label is exclusively fixed on the surface of one body and the second application part of the label is exclusively fixed on the surface of the other body.

53. The arrangement according to claim 50, wherein the diameters of the two bodies deviate from one another in a step-like fashion by at least 5% of the smaller diameter in the region of the transition part of the label.

54. The arrangement according to claim 53, wherein the diameters of the two bodies deviate from one another in a step-like fashion by at least 10% of the smaller diameter in the region of the transition part of the label.

55. The arrangement according to claim 54, wherein the diameters of the two bodies deviate from one another in a step-like fashion by at least 20% of the smaller diameter in the region of the transition part of the label.

56. A method for sealing over a coaxial arrangement of two separable bodies with at least one of a cylindrical region, a prismatic region and a conical region that have different cross-sections in the region of their transition, wherein a label is provided that has two application parts arranged offset relative to one another and connected by means of a transition part, and wherein the label is applied in the tangential direction such that one application part lies on one of the bodies and the other application part lies on the other body and the leading edge of one application part comes in contact with one body before the leading edge of the other application part comes in contact with the other body.

57. The method according to claim 56, wherein the trailing edge of one application part comes in contact with one body before the trailing edge of the other application part comes in contact with the other body.

58. The method according to claim 56, wherein at least two-thirds of the tangential length of one application part lies on one body before the leading edge of the other application part comes in contact with the other body.

59. The method according to claim 58, wherein at least three-fourths of the tangential length of one application part lies on one body before the leading edge of the other application part comes in contact with the other body.

60. The method according to claim 58, wherein the trailing edge of one application part comes in contact with one body (100) before the leading edge of the other application part comes in contact with the other body.
